(19) United States
(12) Patent Application Publication
(10) Pub. No.: US 2013/0134079 A1
(43) Pub. Date: May 30, 2013

(54) MOBILE PHASE SOLVENT DELIVERY MODULE

(71) Applicant: WATERS TECHNOLOGIES CORPORATION, Milford, MA (US)

(72) Inventors: Joseph A. Jarrell, Newton Highlands, MA (US); Pamela C. Iraneta, Brighton, MA (US); Douglas P. Wittmer, Upton, MA (US)

(73) Assignee: WATERS TECHNOLOGIES CORPORATION, Milford, MA (US)

(21) Appl. No.: 13/677,695

(22) Filed: Nov. 15, 2012

Related U.S. Application Data
(60) Provisional application No. 61/564,117, filed on Nov. 28, 2011.

(51) Int. Cl. B01D 15/14

(52) U.S. Cl. CPC B01D 15/14
USPC 210/143; 210/198.2

(57) ABSTRACT

Described is a mobile phase solvent delivery module for liquid chromatography and supercritical fluid chromatography systems. The module includes a pump disposed in a fluid path that conducts a mobile phase solvent. The pump provides the mobile phase solvent at an increased pressure. The module also includes a purification cartridge disposed in the fluid path either before or after the pump. The purification cartridge has an inlet to receive the mobile phase solvent and an outlet to provide a purified mobile phase solvent, and includes a packing material for removing an impurity from the mobile phase solvent. In various embodiments, the module also includes one or more additional components to allow various techniques for regeneration or replacement of spent purification cartridges. For example, the module may also include one or more of a temperature control module, a fluidic switch and one or more additional purification cartridges.

### RELATED APPLICATION

This application claims the benefit of the earlier filing date of U.S. Provisional Patent Application Ser. No. 61/564,117, filed Nov. 28, 2011 and titled “Mobile Phase Solvent Delivery Module,” the entirety of which is incorporated herein by reference.

### FIELD OF THE INVENTION

The invention relates generally to liquid chromatography and supercritical fluid chromatography. More particularly, the invention relates to the purification of a mobile phase in a liquid or supercritical fluid chromatography system.

### BACKGROUND

Many materials used in solvent delivery modules for liquid chromatography (LC) systems can contribute impurities when exposed to the mobile phase. This problem is particularly evident for mobile phases containing acid modifiers. The ability to provide high purity mobile phase for LC measurements takes on increased significance as the sensitivity to impurities in LC systems increases. For example, high performance liquid chromatography (HPLC) and ultra-performance liquid chromatography (UPLC) systems with increased detector sensitivity can be limited by impurities present in the mobile phase.

In many instances, a high purity mobile phase may be commercially available; however, the purity of the mobile phase may decrease while stored in a bottle or container. Thus the mobile phase may become sufficiently impure over time for use in performing high accuracy LC measurements.

### SUMMARY

In one aspect, the invention features a solvent delivery module for a chromatography system. The module includes a fluid path, a pump and a purification cartridge. The fluid path has a path inlet to receive a mobile phase solvent. The pump is disposed in the fluid path. The pump has a pump inlet configured to receive the mobile phase solvent and a pump outlet to provide the mobile phase solvent at an increased pressure. The purification is disposed in the fluid path and includes a packing material for removing an impurity from the mobile phase solvent. The purification cartridge has an inlet to receive the mobile phase solvent and an outlet to provide a purified mobile phase solvent.

In another aspect, the invention features a mobile phase delivery module for a chromatography system. The module includes a plurality of solvent delivery modules, a gradient proportioning valve and a pump. Each solvent delivery module includes a purification cartridge and a solvent reservoir configured to hold a mobile phase solvent. Each purification cartridge includes a packing material for removing an impurity from a respective one of the mobile phase solvents. Each purification cartridge has an inlet in communication with the solvent reservoir to receive the mobile phase solvent and an outlet to provide a purified mobile phase solvent. The gradient proportioning valve has a plurality of valve inlets and a valve outlet. Each valve inlet is in communication with the outlet of a respective one of the purification cartridges. The pump has a pump inlet that is in communication with the valve outlet and a pump outlet that provides a purified mobile phase that includes contributions of the purified mobile phase solvents from the solvent delivery modules.

In another aspect, the invention features a mobile phase delivery module for a chromatography system. The module includes a first pump having a first pump outlet to provide a first mobile phase solvent, a second pump having a second pump outlet to provide a second mobile phase solvent, a first purification cartridge, a second purification cartridge and a mixer. The first purification cartridge has an inlet in communication with the first pump outlet and has an outlet. The second purification cartridge has an inlet in communication with the second pump outlet and has an outlet. The first and second purification cartridges have packing material compositions to remove impurities from the first mobile phase solvent and the second mobile phase solvent, respectively. The mixer has a pair of inlets and an outlet. Each mixer inlet is in communication with one of the outlets of the first and second purification cartridges. The mixer outlet provides a mobile phase that includes a combination of the first and second mobile phase solvents.

In another aspect, the invention features a solvent delivery module for a chromatography system. The module includes a pump, a selectable fluid path module and a plurality of purification cartridges. The pump has a pump inlet to receive a mobile phase solvent and a pump outlet to supply a mobile phase solvent at an increased pressure. The selectable fluid path module has a module inlet in communication with the pump outlet, a module outlet and a plurality of fluid paths. One of the fluid paths is selectably configured to be in communication with the module inlet and the module outlet to receive the mobile phase solvent and to provide the mobile phase solvent, respectively. Each purification cartridge is disposed in a respective one of the fluid paths and includes a packing material for removing an impurity from the mobile phase solvent.

In yet another aspect, the invention features a solvent delivery module for a chromatography system. The module includes a solvent pump, a purge pump, a fluidic switch, a first purification cartridge and a second purification cartridge. The solvent pump has an outlet to supply a mobile phase solvent and the purge pump has an outlet to supply a purge fluid. The fluidic switch has a first fluid path and a second fluid path, and is in communication with the outlets of the solvent pump and the purge pump. The first purification cartridge is disposed in the first fluid path and includes a packing material for removing an impurity from the mobile phase solvent. The second purification cartridge is disposed in the second fluid path and includes a packing material for removing the impurity from the mobile phase solvent. The mobile phase solvent is conducted through the first purification cartridge and the purge fluid is conducted through the second purification cartridge when the fluidic switch is in a first state. The mobile phase solvent is conducted through the second purification cartridge and the purge fluid is conducted through the first purification cartridge when the fluidic switch is in a second state.

### BRIEF DESCRIPTION OF THE DRAWINGS

The above and further advantages of this invention may be better understood by referring to the following description in conjunction with the accompanying drawings, in which like reference numerals indicate like elements and features in the various figures. For clarity, not every element may be labeled in every figure. The drawings are not necessarily to scale, emphasis instead being placed upon illustrating the principles of the invention.

FIG. 1 is a high-level block diagram of an embodiment of a liquid chromatography system to perform isocratic separations using a purified mobile phase.

FIG. 2 is a block diagram of an embodiment of a solvent delivery module for providing a purified mobile phase solvent to a liquid chromatography system.

FIG. 3 is a block diagram of an embodiment of a mobile phase delivery module for providing a purified mobile phase solvent to a liquid chromatography system.

FIG. 4 is a block diagram of a mobile phase delivery module for performing gradient separations in a liquid chromatography system.

FIG. 5 is a block diagram of another embodiment of a mobile phase delivery module for performing gradient separations in a liquid chromatography system.

FIG. 6 is a block diagram of another embodiment of a mobile phase delivery module for performing gradient separations in a liquid chromatography system.

### DETAILED DESCRIPTION

Reference in the specification to “one embodiment” or “an embodiment” means that a particular, feature, structure or characteristic described in connection with the embodiment is included in at least one embodiment of the teaching. References to a particular embodiment within the specification do not necessarily all refer to the same embodiment.

The present teaching will now be described in more detail with reference to exemplary embodiments thereof as shown in the accompanying drawings. While the present teaching is described in conjunction with various embodiments and examples, it is not intended that the present teaching be limited to such embodiments. On the contrary, the present teaching encompasses various alternatives, modifications and equivalents, as will be appreciated by those of skill in the art. Those of ordinary skill having access to the teaching herein will recognize additional implementations, modifications and embodiments, as well as other fields of use, which are within the scope of the present disclosure as described herein.

As detector sensitivity improves, liquid chromatography (LC) and supercritical fluid chromatography (SFC) systems are increasingly limited by impurities in the mobile phase. Although high purity mobile phase solvents can be acquired or generated from a general source of mobile phase, impurities such as those introduced from a container or solvent reservoir can reduce the purity over time. According to various embodiments described herein, a solvent delivery module includes point of use purification of mobile phase solvents for LC systems such as an HPLC or a UPLC system. These solvent delivery modules can reduce or eliminate impurities in the mobile phase that cannot practically be removed by other means.

In brief overview, the solvent delivery module includes a fluid path having an inlet to receive a mobile phase solvent. A pump disposed in the fluid path increases the pressure of the mobile phase solvent. A purification cartridge in the fluid path receives the mobile phase solvent at an inlet and provides a purified mobile phase solvent at an outlet. The purification cartridge can be located on either the low pressure or high pressure side of the pump. As used herein, a purification cartridge can be an item that is easily inserted into and removed from the fluid path. Alternatively, the purification cartridge can be in the form of a column (e.g., a polishing column) that is coupled to the fluid path, for example, by fittings appropriate for high pressure fluid flow. The purification cartridge can be an item configured for routine replacement or may be provided in a regenerative form adapted for long term use. In various embodiments, a number of purification cartridges are provided so that one or more cartridges that are not in the active fluid path can be replaced or regenerated without interfering with operation utilizing another purification cartridge.

FIG. 1 is a high-level block diagram of an embodiment of a LC system 10 to perform isocratic separations. A solvent delivery module 12 provides a mobile phase to an injector 14 which introduces a sample to the mobile phase flowing to an analytical column 16. A purification cartridge 18 is disposed in the fluid path between the solvent delivery module 12 and the injector 14. For HPLC and UPLC systems, the fluid path is under high pressure (e.g., 18 Kpsi or greater) and the cartridge 18 is preferably coupled into the fluid path using high pressure fittings. The purification cartridge 18 contains a packing material having a stationary phase or physical or compositional characteristics selected based on the particular mobile phase or on one or more impurities to be removed from the mobile phase. Impurities can include impurities present in an acquired volume of mobile phase solvent, and impurities introduced by a solvent container, solvent reservoir or pump into the mobile phase.

In the illustrated isocratic system 10, the purification cartridge 18 can contain the same packing material as in the analytical column 16. The purification cartridge 18 is maintained at a temperature sufficiently low as to delay the elution of the impurities on the analytical column 16 so that the impurities do not interfere with analysis. The impurities are washed off or eluted from the purification cartridge 18 either before the start of the next run or at some other desired interval. The LC system 10 can be run in a continuous regeneration mode of the purification cartridge 18 or the regeneration can be performed at a later time. At anytime the regeneration process can be accelerated by increasing the temperature of the purification cartridge 18 using the temperature control module 20.

In reversed-phase chromatography, an estimate of the temperature offset needed to separate an impurity from an analyte can be approximated by a 3% increase in the retention factor k′ for each 1° C. decrease in the temperature of the purge cartridge 18 relative to the temperature of the analytical column 16. For example, if the purification cartridge 18 and analytical column 16 are of equal size, contain a similar or identical packing material and the temperatures of the purification cartridge 18 and the analytical column 16 are maintained at 4° C. and 35° C., respectively, an increase in the retention factor k′ of about 90% is produced for the impurities on the analytical column 16. The elution time delay can be adjusted as desired by selecting or optimizing the individually controllable purification cartridge and analytical column temperatures. Preferably, active pre-column heating is used to prevent a mismatch between the analytical column temperature and the temperature of the solvent at the analytical column 16.

For the purpose of purifying mobile phase solvents, the highest capacity for impurities is typically obtained from materials having the highest specific surface area; however, porous graphitic carbon (PGC) is an exception. The retention properties of PGC such as Hypercarb® (available from Thermo Fisher Scientific of Waltham, Mass.) are unique relative to other chromatographic packing materials. PGC has higher retention for highly polar compounds than for moderately polar compounds. PGC can be more retentive for highly polar compounds than many materials having significantly higher specific surface areas. Thus PGC is a good choice for removing surfactants from aqueous mobile phases and is well suited for removing many impurities from strongly basic aqueous mobile phases (i.e., aqueous mobile phases having a pH greater than 12) due to its long term stability. For other impurities, high surface area polymer sorbents such as Oasis® hydrophilic-lipophylic-balanced (HLB) sorbent (available from Waters Corporation of Milford, Mass.) may be used.

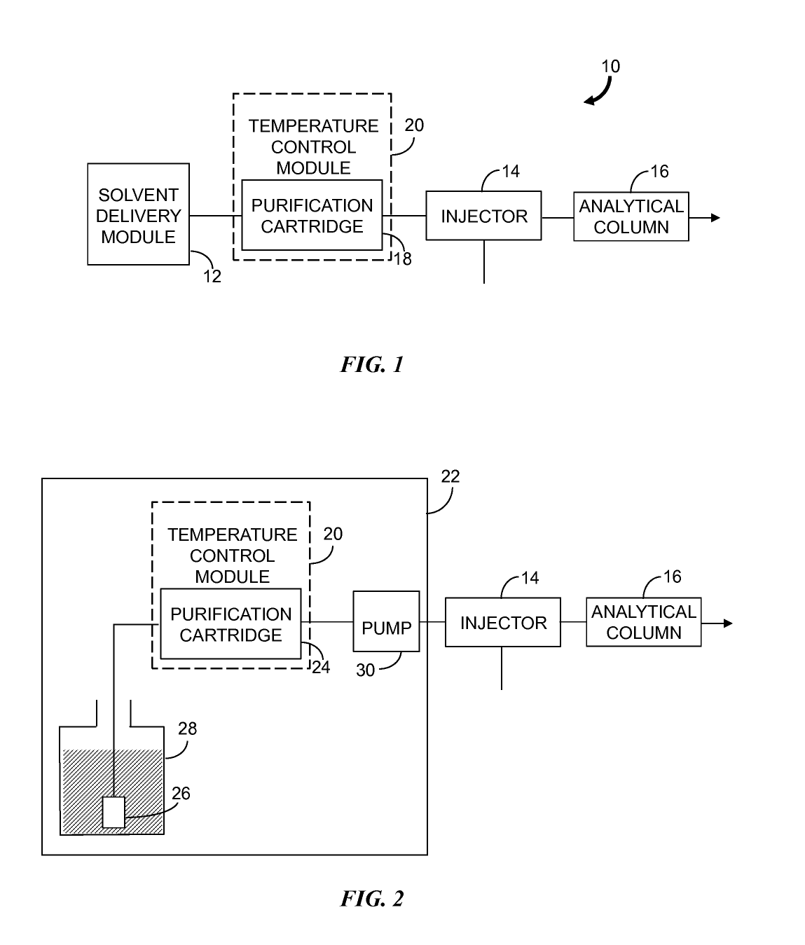

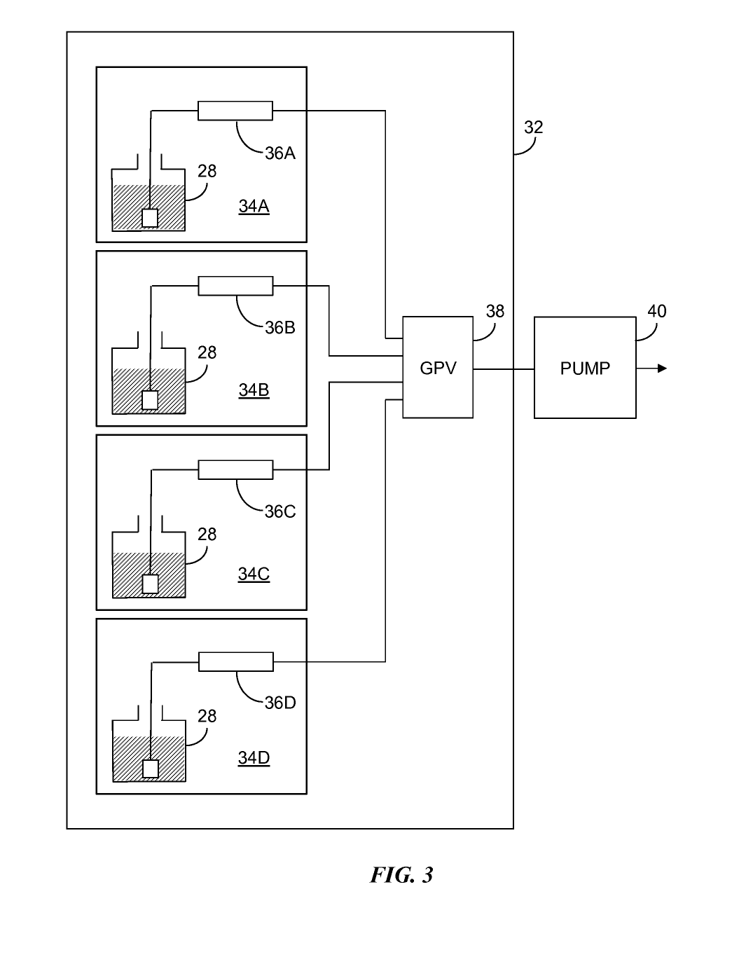

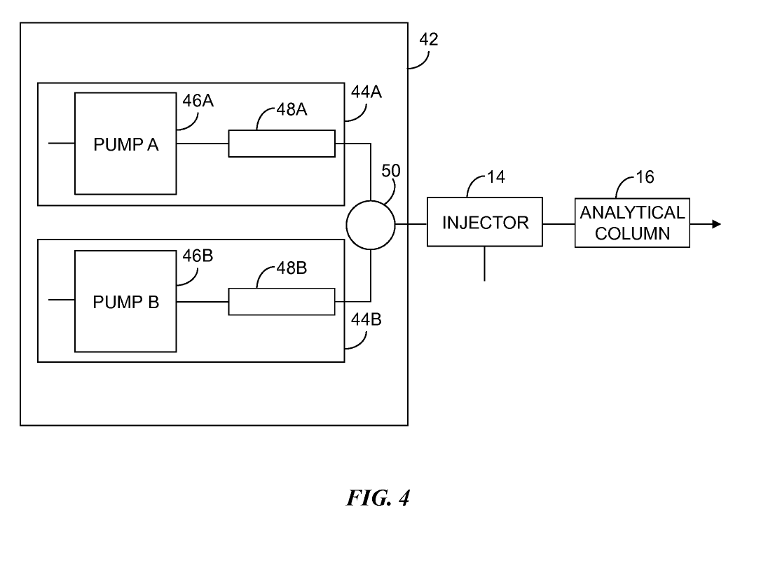

For purification cartridges intended for use with high aqueous mobile phases (i.e., less than about 5% to 15% organic) on the low pressure side of an LC system, for example, as shown in FIGS. 2 and 3 and described below, the cartridges preferably contain packing materials that are water wettable at atmospheric pressure and are preconditioned with organic prior to installation. The Oasis HLB sorbent is appropriate for this purpose because it has both a high specific surface area and is water wettable at atmospheric pressure.

For purification cartridges intended for use with high aqueous mobile phases on the high pressure side of the solvent delivery pumps, such as shown in FIG. 1 and FIGS. 4 to 6, the cartridges preferably contain packing materials that are water wettable under chromatographic pressures and are preconditioned with organic solvent prior to installation. Oasis HLB is also a suitable choice for use in such systems; however, several packing materials have been developed to withstand “dewetting” in low organic mobile phases such as polar embedded group C18 stationary phases or specifically designed low coverage C18 stationary phases. The performance of a purification cartridge can be maintained as long as the cartridge is maintained under constant chromatographic pressure and is reconditioned with organic solvent whenever the flow rate is interrupted. The system pressure ensures contact between the mobile phase and the stationary phase during use and prevents dewetting.

To remove polar impurities from the numerous types of organic solvents in use today, a variety of normal phase packing materials are available for selection based on specific impurities. By way of specific examples, suitable phase packing materials include silica, alumina, zirconia, and titania. In addition, ion exchange resins can be used to remove ionic impurities.

Bead-shaped activated carbon (BAC) (available from Kureha America Inc. of New York, N.Y.) is an example of another packing material and can be used in purification cartridges to remove impurities from either water or organic solvents. BAC materials contain relatively low amounts of carbon fines but some initial shedding can occur therefore conditioning a cartridge off-line with the solvent prior to system installation is desirable. Preferably, a small guard column of the same material and particle size as the analytical column is attached at the outlet of the purification cartridge to prevent migration of the BAC fines to the inlet of the analytical column.

As described above, mobile phase impurities increasingly partition into the stationary phase of the purification cartridge 18 as the cartridge temperature decreases. As illustrated in FIG. 1, the purification cartridge 18 is a regenerative-type cartridge that is maintained at a low temperature (e.g., 4° C.) by a temperature control module 20 to achieve improved purification efficiency. The ability to purify the mobile phase decreases after prolonged use as impurities accumulate in the cartridge 18. Advantageously, the purification cartridge 18 does not have to be replaced. Instead, to remove saturated impurities the system 10 is brought offline. A purge fluid is passed through the purification cartridge 18 while it is maintained at an elevated temperature by the temperature control module 20. For example, a purge fluid of strong solvent strength that is compatible with the stationary phase and exhibits good solvating properties for the impurities is introduced into the cartridge 18 at the elevated temperature. By way of a specific example, an XBridge™ C18 column (available from Waters Corporation of Milford, Mass.) was purged with acetonitrile at 80° C. for 4 hr after running multiple mass spec experiments in which the column was used to remove a phthalate contaminant. After the regeneration process is completed, the system 10 is returned to normal operation. In an alternative embodiment, the purification cartridge 18 is a consumable component that is replaced periodically or in response to a determination that the purification efficiency has decreased significantly. In another alternative embodiment, the purification cartridge 18 is replaced with another purification cartridge, and the original cartridge 18 is remotely regenerated and made available for reuse in the LC system 10 at a later time.

FIG. 2 is a block diagram of an embodiment of a solvent delivery module 22 for providing a purified mobile phase solvent to a LC system. The module 22 includes a purification cartridge 24 disposed in a fluid path between a solvent line sinker 26 in a solvent reservoir 28 and a high pressure pump 30. Advantageously, a large cartridge volume is possible because the purification cartridge 24 is located in the low pressure region of the fluid path. In addition, the cartridge wall that surrounds the packing material can be made of a plastic material whereas a purification cartridge for use in a high pressure fluidic environment generally requires a thick cartridge wall fabricated from a stronger wall material such as stainless steel. In preferred embodiments, the volume capacity of the purification cartridge 18 is substantially greater than the volume capacity of the analytical column 16. An increased volume allows for longer use before impurity saturation occurs and the purification cartridge 24 is regenerated using a temperature control module 20 as described above with respect to FIG. 1. In alternative embodiments, the purification cartridge 24 is a consumable replacement component or a removable component that can be regenerated offline.

FIG. 3 shows an embodiment of a mobile phase delivery module 32 for providing a purified mobile phase solvent to a LC system. The delivery module 32 includes four solvent delivery modules 34A, 34B, 34C and 34D. Each solvent delivery module 34 includes a solvent reservoir 28 containing a unique mobile phase solvent and a purification cartridge 36A, 36B, 36C and 36D in the fluid path between the solvent reservoir 28 and a respective inlet of a gradient proportioning valve GPV 38. The valve 38 modulates the low pressure flow contributions of each mobile phase solvent. The output of the valve 38 is in fluidic communication with the inlet of a mobile phase pump 40. Although not shown, means for mixing the metered volumes of the mobile phase contributions may be provided between the gradient proportioning valve 38 and the mobile phase pump 40. Beneficially, each purification cartridge 36 contains a stationary phase that is appropriate for the respective mobile phase solvent or for removing one or more specific impurities for the respective mobile phase solvent.

In an alternative embodiment, the four purification cartridges 36 are replaced by a single purification cartridge disposed between the gradient proportioning valve 38 and the mobile phase pump 40. This alternative embodiment has the advantage of reduced complexity and cost; however, the ability to isolate specific impurities according to each mobile phase solvent is sacrificed.

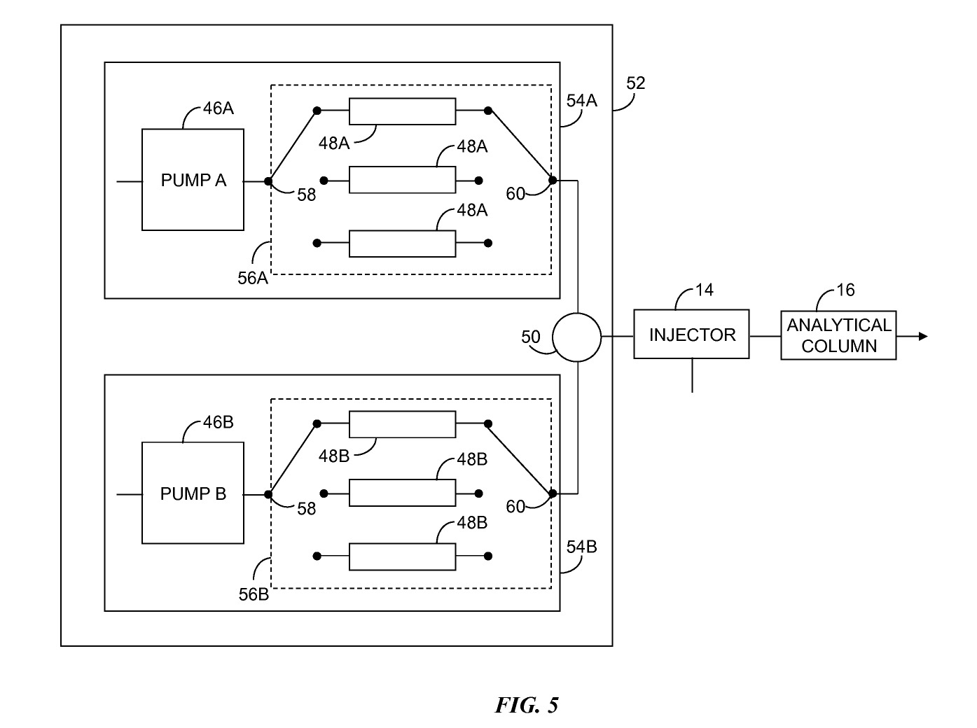

FIG. 4 is a block diagram of a mobile phase delivery module 42 that can be used to perform gradient separations in a LC system. The module 42 includes two solvent delivery modules 44A and 44B. The first solvent delivery module 44A includes a pump 46A that provides a pressurized mobile phase solvent through a purification cartridge 48A to a first inlet of a mixer 50 and the second solvent delivery module 44B includes a pump 46B that provides a different pressurized mobile phase solvent through a purification cartridge 48B to a second inlet of the mixer 50. Preferably, the composition of each purification cartridge 48 is tailored to the specific mobile phase and impurities to be removed. The mobile phase solvent exiting the outlet of the mixer 50 contains the contributions of the two mobile phase solvents. The flow rates of the two pumps 46 are changed over time to change the ratio of the contributions of the two solvents and thus change the elution strength of the mobile phase provided to the analytical column 16. As described with respect to other embodiments above, each purification cartridge 48 can be in the form of a consumable cartridge that can be replaced or in the form of a regenerative cartridge capable of inline regeneration or removal and remote regeneration.

FIG. 5 is a block diagram of another embodiment of a mobile phase delivery module 52. The module 52 includes two solvent delivery modules 54A and 54B that are configured similarly to the solvent delivery modules 44 of FIG. 4; however, instead of a single purification cartridge 48, each solvent delivery module includes a selectable fluid path module 56A or 56B having a plurality of purification cartridges 48A and 48B, respectively. Each selectable fluid path module 56 includes a module inlet 58 in communication with the outlet of the respective pump 46, a module outlet 60 in communication with one of the mixer inlets, and a plurality of fluid paths. One of the fluid paths can be selected to be in communication with the module inlet 58 and the module outlet 60 to receive the mobile phase solvent and to provide the purified mobile phase solvent, respectively. Each of the fluid paths includes a purification module 48 adapted for the particular mobile phase solvent supplied by the respective pump 46.

A control module can communicate with the selectable fluid path modules 56 via one or more control signals to configure a particular fluid path to conduct the mobile phase solvent. Alternatively, the selectable fluid path modules 56 can be manually reconfigurable. Purification cartridges 48 that are spent are taken offline (i.e., removed from the active mobile phase solvent path) and can be replaced or regenerated as described above.

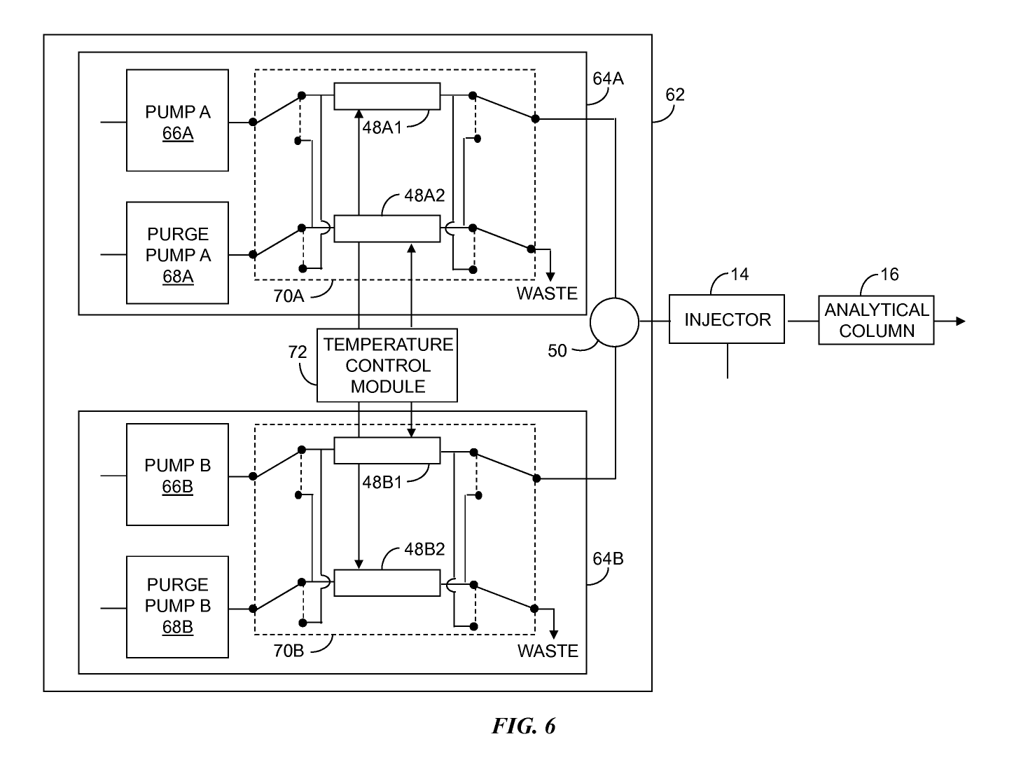

The block diagram of FIG. 6 depicts another embodiment of a mobile phase delivery module 62. The module 62 includes two solvent delivery modules 64A and 64B. Each module 64 includes a solvent pump 66, a purge pump 68, and a fluidic switch 70. Each fluidic switch 70 is in fluidic communication with the outlets of the solvent pump 66 and purge pump 68. In addition, each fluid switch 70 has a first fluid path that includes a first purification cartridge 48 and a second fluid path that includes a second purification cartridge 48.

The mobile phase delivery module 62 is capable of operation in a LC system while regenerating a subset of the purification cartridges 48. For the illustrated state of the fluidic switches 70, a gradient separation is performed by passing a mobile phase solvent supplied by the solvent pump 66A through the upper purification cartridge 48A1 of the upper solvent delivery module 64A to the mixer 50. Similarly, a mobile phase solvent supplied by the solvent pump 66B passes through the upper purification cartridge 48B1 of the lower solvent delivery module 64B to the mixer 50. Purification cartridges 48A2 and 48B2 having reduced purification efficiency from prior use and are maintained offline. Purge fluids provided by the purge pumps 68 are passed through the offline purification cartridges 48A2 and 48B2 and on to a waste receptacle or conduit during an offline regeneration process.

In the illustrated embodiment, a temperature control module 72 adjusts the temperature of each purification cartridge 48 according to its mode of operation. For example, the online purification cartridges 48A1 and 48B1 are maintained at a lower temperature for improved purification efficiency and the offline purification cartridges 48A2 and 48B2 are maintained at a higher temperature for improved regeneration.

After extended use, the online purification cartridges 48A1 and 48B1 will accumulate impurities and become less efficient at removing impurities from the mobile phase solvents. Thus the fluidic switches 70 are changed to a complementary state in which the lower purification cartridges 48A2 and 48B2 of the solvent delivery modules 64 are place online and the upper purification cartridges 48A1 and 48B1 are taken offline for regeneration.

Various embodiments of the solvent delivery module or mobile phase delivery module, such as the embodiments described above, may be implemented in a variety of LC systems. In some embodiments, one or more of the module components are provided as part of a chip-based LC system. By way of examples, LC systems that may be adapted to include or interface with embodiments of the solvent delivery module and mobile phase delivery module include the ACQUITY® and TRIZAIC® LC/MS systems available from Waters Corporation of Milford, Mass.

While the invention has been shown and described with reference to specific embodiments, it should be understood by those skilled in the art that various changes in form and detail may be made therein without departing from the spirit and scope of the invention as recited in the accompanying claims.

What is claimed is:

1. A solvent delivery module for a chromatography system, comprising:
a fluid path having a path inlet to receive a mobile phase solvent;
a pump disposed in the fluid path and having a pump inlet configured to receive the mobile phase solvent and a pump outlet to provide the mobile phase solvent at an increased pressure; and
a purification cartridge comprising a packing material for removing an impurity from the mobile phase solvent, the purification cartridge disposed in the fluid path and having an inlet to receive the mobile phase solvent and an outlet to provide a purified mobile phase solvent.

2. The solvent delivery module of claim 1 further comprising a solvent reservoir in communication with the path inlet and configured to hold a mobile phase solvent.

3. The solvent delivery module of claim 1 wherein the outlet of the purification cartridge is communication with the pump inlet.

4. The solvent delivery module of claim 3 further comprising a gradient proportioning valve disposed in the fluid path between the path inlet and the purification cartridge, the gradient proportioning valve having a first valve inlet to receive the mobile phase solvent, at least one additional valve inlet to receive at least one additional mobile phase solvent, and a valve outlet to provide a proportioned mixture of the mobile phase solvent and the at least one additional mobile phase solvent.

5. The solvent delivery module of claim 1 wherein the inlet of the purification cartridge is in communication with the pump outlet.

6. The solvent delivery module of claim 1 further comprising a temperature control module in thermal communication with the purification cartridge.

7. The solvent delivery module of claim 1 wherein the packing material is selected from a group consisting of a porous graphitic carbon, a polymer sorbent and a bead-shaped activated carbon.

8. A mobile phase delivery module for a chromatography system, comprising:
a plurality of solvent delivery modules each comprising a solvent reservoir configured to hold a mobile phase solvent and a purification cartridge, each of the purification cartridges comprising a packing material for removing an impurity from a respective one of the mobile phase solvents and having an inlet in communication with the solvent reservoir to receive the mobile phase solvent and an outlet to provide a purified mobile phase solvent;
a gradient proportioning valve having a plurality of valve inlets each in communication with the outlet of a respective one of the purification cartridges and having a valve outlet; and
a pump having a pump inlet in communication with the valve outlet and having a pump outlet to provide a purified mobile phase comprising contributions of the purified mobile phase solvents from the solvent delivery modules.

9. The mobile phase delivery module of claim 8 wherein at least one of the solvent delivery modules further comprises a temperature control module in thermal communication with the purification cartridge.

10. A mobile phase delivery module for a chromatography system, comprising:
a first pump having a first pump outlet to provide a first mobile phase solvent;
a second pump having a second pump outlet to provide a second mobile phase solvent;
a first purification cartridge having an inlet in communication with the first pump outlet and having an outlet, the first purification cartridge having a packing material composition to remove impurities from the first mobile phase solvent;
a second purification cartridge having an inlet in communication with the second pump outlet and having an outlet, the second purification cartridge having a packing material composition to remove impurities from the second mobile phase solvent; and
a mixer having a pair of inlets each in communication with one of the outlets of the first and second purification cartridges and having an outlet to provide a mobile phase comprising a combination of the first and second mobile phase solvents.

11. The mobile phase delivery module of claim 10 further comprising a temperature control module in thermal communication with the first and second purification cartridges.

12. A solvent delivery module for a chromatography system, comprising:
a pump having a pump inlet to receive a mobile phase solvent and a pump outlet to supply a mobile phase solvent at an increased pressure;
a selectable fluid path module having a module inlet in communication with the pump outlet, a module outlet, and a plurality of fluid paths, wherein one of the fluid paths is selectably configured to be in communication with the module inlet and the module outlet to receive the mobile phase solvent and to provide the mobile phase solvent, respectively; and
a plurality of purification cartridges each disposed in a respective one of the fluid paths, each of the purification cartridges comprising a packing material for removing an impurity from the mobile phase solvent.

13. The solvent delivery module of claim 12 further comprising a control module in communication with the selectable fluid path module to switch a configuration of the fluid paths with respect to the module inlet and the module outlet in response to a control signal.

14. The solvent delivery module of claim 12 wherein a configuration of the fluid paths with respect to the module inlet and the module outlet is manually reconfigurable.

15. The solvent delivery module of claim 12 further comprising a temperature control module in thermal communication with the purification cartridges.

16. The solvent delivery module of claim 12 further comprising a mixer having a first mixer inlet in communication with the module outlet of the selectable fluid path module to receive the mobile phase solvent and having a second mixer inlet to receive a different mobile phase solvent.

17. A solvent delivery module for a chromatography system, comprising:
a solvent pump having an outlet to supply a mobile phase solvent;
a purge pump having an outlet to supply a purge fluid;
a fluidic switch in communication with the outlets of the solvent pump and the purge pump, the fluidic switch having a first fluid path and a second fluid path;
a first purification cartridge disposed in the first fluid path and comprising a packing material for removing an impurity from the mobile phase solvent; and
a second purification cartridge disposed in the second fluid path and comprising a packing material for removing the impurity from the mobile phase solvent,
wherein the mobile phase solvent is conducted through the first purification cartridge and the purge fluid is conducted through the second purification cartridge when the fluidic switch is in a first state and wherein the mobile phase solvent is conducted through the second purification cartridge and the purge fluid is conducted through the first purification cartridge when the fluidic switch is in a second state.

18. The solvent delivery module of claim 17 wherein the fluidic switch is in communication with a mobile phase path of a liquid chromatography system so that the mobile phase solvent conducted through the first purification cartridge is provided to the mobile phase path when the fluidic switch is in the first state and wherein the mobile phase solvent conducted through the second purification cartridge is provided to the mobile phase path when the fluidic switch is in the second state.

19. The solvent delivery module of claim 18 wherein the mobile phase path comprises a mixer having a first mixer inlet to receive the mobile phase solvent and a second mixer inlet to receive a different mobile phase solvent.

20. The solvent delivery module of claim 17 further comprising a temperature control module in thermal communication with the first and second purification cartridges.
